(19) United States
(12) Patent Application Publication
(10) Pub. No.: US 2009/0203509 A1
(43) Pub. Date: Aug. 13, 2009

(54) Unit and Method for Folding Corrugated Board Sheets

(76) Inventor: Lennart Wiklund, Orebro (SE)

Correspondence Address: HARNESS, DICKEY & PIERCE, P.L.C., P.O. BOX 8910, RESTON, VA, 20195, US

(21) Appl. No.: 12/224,166

(22) PCT Filed: Feb. 14, 2007
(86) PCT No.: PCT/IB2007/001462

§ 371 Date: Dec. 18, 2008

(30) Foreign Application Priority Data
Feb. 21, 2006 (SE) 0600372-7

(51) Int. Cl. B31B 1/58; B31F 1/00; B31B 3/52

(52) U.S. Cl. 493/179; 493/439

(57) ABSTRACT

A folding unit for corrugated board sheets (18) in in-line manufacturing of corrugated board boxes, comprising a pair of parallel and laterally displaceable folding beams (1, 2) with a respective endless conveyor belt (3, 4), which extend from the inlet (19) of the folding unit to a pair of rolls (14) at the outlet (20) of the folding unit. A pair of folding rules (6) are arranged under the respective folding beams (1, 2) and extend from the inlet (19) of the folding unit and towards, but not all the way to, the outlet (20) of the folding unit. A pair of folding bars (33, 34) which are fixedly positioned outside the respective folding rules (6) and at an angle to the respective folding rules are arranged in the front portion of the folding unit, as seen in the transport direction (15) of the corrugated board sheets (18). A pair of folding belts (7, 8) are arranged under a respective folding beam (1, 2) to cooperate therewith and extend from an associated front deflecting roller (16) after the terminal end of the folding bars (33, 34), as seen in the transport direction (15), to an associated deflecting roller (17) with a horizontal axis substantially adjacent the pair of rolls (14). A post-creaser (81) is positioned under the respective folding beams (1, 2), between the rear end of each folding rule (6), as seen in the transport direction (15), and the associated front deflecting roller (16). Each post-creaser comprises a creasing wheel (82) which is formed as a double-cone and which is rotatably arranged on an adjustable bracket (83) to deform, in cooperation with the associated folding beam (1, 2) and an abutment (90), the beads (75, 76) forming at the folding line (74) as the corrugated board sheet (18) is being folded.

The present invention relates to a folding unit for corrugated board sheets in in-line manufacturing of corrugated board boxes, comprising a pair of parallel and laterally displaceable folding beams with a respective endless conveyor belt, which extend from the inlet of the folding unit to the outlet of the folding unit, a pair of folding rules, which are arranged under the respective folding beams and which extend from the inlet of the folding unit and towards, but not all the way to, the outlet of the folding unit, a pair of folding bars, which are fixedly positioned outside the respective folding rules and at an angle to the respective folding rules and which are arranged in the front portion of the folding unit, as seen in the transport direction of the corrugated board sheets, a pair of folding belts, which are arranged under a respective folding beam to cooperate therewith and which extend from an associated front deflecting roller after the terminal end of the folding bars, as seen in the transport direction, to an associated deflecting roller with a horizontal axis substantially adjacent the outlet, a corrugated board sheet supplied to the inlet of the folding unit being gripped by said pair of conveyor belts, being transported along the folding rules, and the two outer panels of the corrugated board sheet being folded successively from 0° by the respective folding bars in cooperation with the associated folding rule, after which each folded panel is brought into engagement with the respective folding belts and the folding beam cooperating therewith for continued folding and subsequently leaves the respective folding beams to be finally delivered at the outlet by the pair of deflecting rollers with a horizontal axis, with the panels folded 180°.

The invention also relates to a method of folding corrugated board sheets in in-line manufacturing of corrugated board boxes, comprising the steps of feeding at a regular rate corrugated board sheets into a folding unit during sizing, successively folding, in the first portion of the folding unit, as seen in the transport direction of the corrugated board sheet, the two outer panels of the corrugated board sheet from 0° by means of a pair of folding beams and a pair of folding bars cooperating therewith, successively folding, in the second portion of the folding unit, as seen in the transport direction of the corrugated board sheet, the two outer panels of the corrugated board sheet to 180° by means of a pair of folding belts and said pair of folding beams, and guiding, by means of a guide bar, the folded corrugated board sheet between a pair of rolls for adhering a glue flap of one of the folded panels to the other folded panel.

Modern manufacturing of corrugated board boxes takes place in so-called in-line machines. These machines are characterised in that all the operations are performed in line in one and the same machine. Corrugated board sheets or blanks, which are adjusted to the dimensions of the boxes that are to be made, are fed one by one at a regular rate by a feeding unit into the in-line machine.

Subsequently, the sheets are printed in one or more printing units located after the feeding unit. This is followed by creasing, slotting and cutting of a glue flap, which is performed in the slotting unit of the machine. The next operation is to optionally punch out air holes, carrier holes or other punching, depending on the design of the boxes. This is performed in the so-called punching unit. After the punching unit comes the folding unit. In this unit, glue is applied to the glue flap of the sheet, after which the outer panels of the sheet are folded 180°. The glue flap is adhered to the outer part of the panel on the opposite side of the sheet. Finally, the box blanks are counted and bundled.

The finished box blanks are delivered in a flat condition, folded and glued. It is not until the box blanks are to be used and filled with the intended products that they are erected to form boxes.

Increasingly high quality requirements are placed on corrugated board boxes, which means that the in-line machines must have the capacity to produce boxes with increasingly high precision as concerns both printing and dimension stability. The latter results in high demands on the precision of the folding which takes place in the in-line machines.

In the erecting machine, the flat “box blank” is erected and the bottom of the box sealed. Inferior folding may result in problems of the bottom flaps getting stuck in each other and in production disturbances.

In the filling and sealing machine, the products are introduced, for instance, by a robot and, in this connection, it is important for the boxes not to be too narrow since this causes problems and production disturbances. When the cover is sealed, the flaps should not, of course, get stuck in each other and cause production disturbances.

The boxes should not be too big inside. The aim is to produce a box that is as tight as possible so that the products will not have enough room to move around in the box.

In the manufacturing of the initial material, i.e. the corrugated board sheets, different paper grades are used. Corrugated board is composed of different paper layers with varying grades. The thickness of the corrugated board depends on the number of paper layers, the flute height and the grade of the different paper layers. The purpose of using different grades of the corrugated board is to adjust the initial material to the various properties required for different corrugated board boxes. For instance, some boxes require greater strength due to the properties of the products that are to be packed. Other corrugated board boxes may require properties favouring better printing quality, etc. In addition, there is a continued strive for lower manufacturing costs, which results in increasing use of paper based on recycled fibres in the manufacturing of the corrugated board sheets.

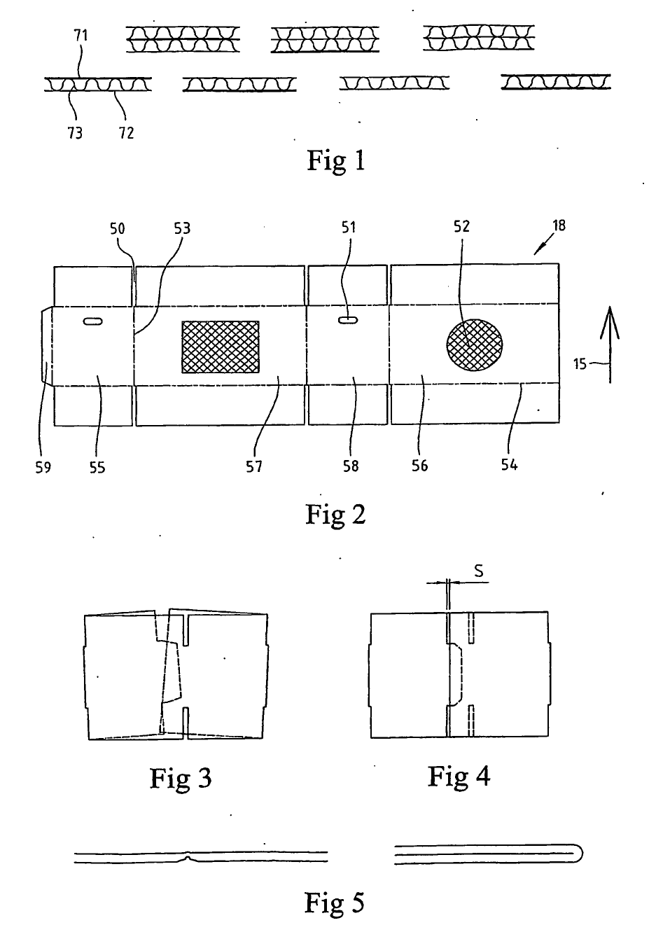

The corrugated board sheets consist of different paper layers, so-called liners 71, 72 and corrugated layers, so-called flutings 73, see FIG. 1 which shows different variants of corrugated board sheets.

Since the corrugated board sheets can consist of various combinations of paper grades, combinations of flutes and different numbers of paper layers, the corrugated board sheets can be adapted to different needs. This simultaneously means that difficulties related to the corrugated board arise when the sheets are folded in the in-line machines.

A large number of grades of corrugated board are thus used in the manufacturing of corrugated board boxes. Owing to this, greater demands are placed on the in-line machines to produce highest possible quality of the corrugated board boxes while using a great variety of grades of the initial material, i.e. the corrugated board sheets.

The dimensions and geometry of the boxes as well as problem-free assembly are important factors in the automatic erecting, filling and sealing lines which are generally used for packing various products in corrugated board boxes. The folding precision is of vital importance to achieve these properties and is thus important for the quality and performance criteria of in-line machines.

Before the sheets are folded in the machine, fold indications in the form of creasing are applied to the sheets. This is carried out in the slotting unit of the machine (see FIG. 2).

With reference to FIG. 2 in the drawings, a corrugated board sheet 18 is illustrated, which has passed through the feeding unit, the printing unit, the slotting unit and the punching unit of the in-line machine and is about to be fed into the folding unit in the direction indicated by the arrow 15. The corrugated board sheet 18 is then completely flat, i.e. unfolded, and has been provided with opposite slots 50 and intermediate creasing lines 53 along which the corrugated board sheet is to be folded in the folding unit. The corrugated board sheet 18 is already provided with punched-out carrier holes 51 and printed matter 52, if required. The creasing lines 53 between the pairs of slots 50 and grooving lines 54 transversely to the creasing lines are used later when the corrugated board box is to be erected (not shown). In the shown embodiment, the corrugated board sheet 18 consists of two outer panels 55, 56 and two inner panels 57, 58. In the folding unit, the outer panels 55, 56 are folded 180° along the associated creasing lines 53 so as to be brought into contact with the inner panels 57, 58, a glue flap 59 on one of the outer panels 55 being adhered to the other outer panel 56. In this condition, the folded corrugated board sheet 18 can be bundled together with a plurality of similar, folded corrugated board sheets for transport to a consignee. The box blanks are bundled in the counting unit of the machine.

One fundamental condition for the folding to be successful is that the sheets are transported in an absolutely straight and controlled manner through all the working processes in the in-line machine. If the sheet turns, i.e. is not transported absolutely parallel into the in-line machine, the folding will not correspond to the fold indications applied to the sheets by creasing in the slotting unit of the machine. The condition for precision in folding has thus disappeared. The fold indication, i.e. the creasing, can also be displaced and positioned obliquely in the sheet due to uneven transport of the sheet through the machine.

Another fundamental condition for successful folding is that the actual folding process is performed in a flexible and controlled manner so that the folded panels are not negatively affected, which may result in “fishtailing”. In that case, the panels are not, as shown in FIG. 3, folded parallelly but taper on one side of the sheet.

With today's modern and advanced in-line machines, it is possible to satisfactorily master the above-described fundamental conditions for successful folding. It is, however, much more difficult to achieve high precision for minimum variations or deviations from one box to the next in the distance between the outer edges of the outer panels, which meet each other after the 180° folding of each of the panels, as shown in FIG. 4. This aspect of the folding precision is of vital importance in order to achieve problem-free and safe handling of the corrugated board boxes in the automatic erecting machines.

The various grades of corrugated board have a direct influence on the variation in the distance of the “gap” S between the folded panels in FIG. 4 from one box blank to the next. Some grades are more difficult to fold than others. By adjusting and designing the profile of the creasing and pre-creasing wheels in the slotting unit of the machine, it is possible, to a certain extent, to improve the folding precision, thus reducing the variation in the distance between the folded panels, the “gap”, from one box to the next. The difficulty of achieving sufficiently high folding precision or precision of the “gap in joint” has increased. The reason for this is that the amounts of corrugated board grades which are critical for the folding have increased. In particular, the growing use of corrugated board grades based on recycled fibres has contributed to making folding more difficult in the in-line machines.

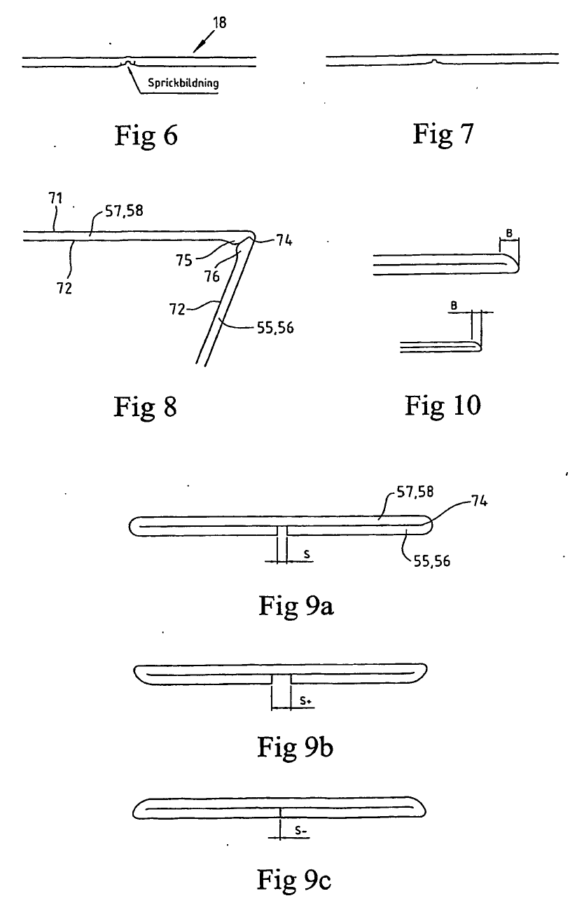

The problem is related to the factors having an impact on the precision of the actual folding. The creasing is intended to be a fold indication which can directly determine exactly where the folding is to be performed. Optimal folding takes place at the fold indication, see FIG. 5. Depending on the grade of the corrugated board, there may be more or less significant deviations in the folding precision. This is due to the different properties of the corrugated board. The growing problems with the increasing amounts of paper based on recycled fibres are caused by the short fibres in these grades, which make the paper brittle and cause it to crack easily when subjected to pressure and stretch, see FIG. 6. Owing to the brittle liner of the corrugated board, it is necessary to reduce the creasing pressure to avoid cracking, which is undesirable for aesthetic reasons and because of the weakening of the strength of the boxes, so that cracks will not form when creasing, see FIG. 7.

If the creasing is not sufficiently pronounced, there is less chance that the folding will be successful and take place exactly according to the applied creasing indication.

In some corrugated board grades, either the inner or the outer liner or both liners crack when the creasing, which is necessary to obtain a sufficiently pronounced fold indication, is applied. It is then necessary to reduce the creasing pressure to avoid cracking. When the creasing pressure is not strong enough, only the inner liner is partially deformed. The outer liner is not marked at all, cf. FIG. 7. The condition for folding precision is that there is a good and distinct fold indication made by sufficiently pronounced creasing. It is characterised by a marking of the inner as well as the outer liner.

At one stage of the folding process, the inside of the corrugated board sheet (the liner), for instance 72, engages the opposite side at the folding line 74, as seen in FIG. 8.

Depending on the grade of the corrugated board, more or less thick beads 75, 76 form on both sides of the folding line 74 at the inside 72 when the outer panels 55, 56 of the sheet are folded inwardly towards the inner panels 57, 58 in the in-line machine. The reason for this is that excess material forms due to the fact that the folding is controlled by the outside 71 of the corrugated board.

Therefore, at this stage, the folding will be partially controlled by the force generated by the contact between the inner surfaces (inside 72) of the corrugated board around the folding line 74. Since there is a formation of excess material at the inside of the box blanks around the folding line, bead formations 75, 76 appear. Because of these bead formations, the folding can “roll” over, away from the folding line at one side or the other, which contributes to the degradation of the folding precision. As a result, the folding will be directly affected by said force and vary from one box blank to the other, as appears from FIG. 9.

FIG. 9a shows a correct folding which results in the desired gap S. FIG. 9b shows a defective folding which has “rolled” over, away from the folding line to one side, thus resulting in too wide a gap S+. FIG. 9c shows a defective folding which has instead “rolled” over, away from the folding line to the other side, thus resulting in too narrow a gap S−. The thicker the corrugated board is, the greater the deviation in precision can be due to said defective folding, as indicated by B in FIG. 10 (cf. FIG. 9c).

When using corrugated board consisting of thicker (stronger) paper grades based on kraft liner, folding also becomes more difficult in spite of the fact that these paper grades allow pronounced marking of creasing without cracking of the paper. Owing to the thicker liner grade, the bead formation described above around the folding line gets a greater force of its own to affect the folding in an undesirable manner.

The reason for the “gap variations” (S) in the folding related to the corrugated board is that the inherent tensions in the corrugated board, in combination with the bead formation occurring on the inner liner (paper) of the box blank, are considerably greater when using thicker grades of corrugated board. This contributes to making folding more difficult and to the deterioration of the precision.

There is a direct connection between the thickness of the corrugated board and the magnitude of the “gap variations”. As a general rule, thicker corrugated board implies greater “gap variations”, which can be seen in FIG. 10.

Other factors having an influence on the folding and folding precision are differences in strength and grammage between different liners and flutings of the corrugated board. The outer liner can be thicker than the inner liner. The inverse relation can sometimes also be the case, the inner liner being thicker than the outer liner. The relationship between the fluting and the grades of the surrounding liners also affects the folding in a greater or less degree, see FIG. 1. The reason for the many combinations of outer liner, inner liner and fluting is that the properties of the box blanks are adjusted to the subsequent use.

It appears from the above analysis that there are, in principle, great possibilities of variation of the grade of the corrugated board. This is used to adjust the properties of the box blanks to the subsequent application of the erected boxes. As a rule, the nature of the items that are to be packed and the costs involved decide the choice of corrugated board grade. The various grades of corrugated board cause different folding problems in the in-line machines. The invention makes it possible to considerably reduce the folding problems related to the corrugated board.

### Prior-Art Technique for Solving Folding Problems Related to the Corrugated Board in In-Line Machines

By designing the profiles of the creasing tools that are mounted in the slotting unit of the in-line machine in a manner that is as suitable as possible for the corrugated board grade, it is to some extent possible to affect the folding and reduce the variations in folding. It is desirable for the marking of the folding line, which is created by the nose of the creasing profile, to be as pronounced as possible without cracking of the corrugated board. The shoulders of the creasing profile should be formed as advantageously as possible for the folding of, for instance, the last 30° of the 180° folding to minimize the risk of the folding being uncontrolled in the manner shown in FIG. 9.

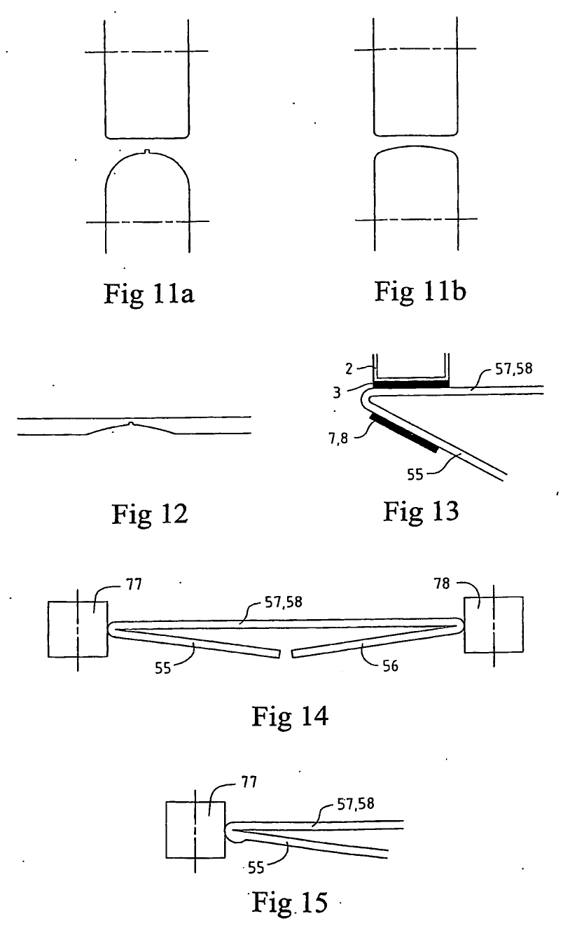

By providing a pre-creaser in the slotting unit of the machine, there are further possibilities, in addition to creasing, of affecting, in combination with the creaser, the folding precision in the area of the folding line depending on the grade of the corrugated board. This combination possibility, see FIG. 11, allows a certain adjustment of the capacity of the machine to fold different board grades with acceptable precision.

Pre-creasing and creasing are performed in the slot, when the sheet is still flat and before folding. However, both the creaser (FIG. 11a) and the pre-creaser (FIG. 11b) have natural limits as to their impact on the folding precision. This is because creasing and pre-creasing can only to some extent neutralize the tensions occurring in the inner liner of the corrugated board boxes, see FIG. 8. By considerable deformation of the corrugated board in the creaser and in the pre-creaser, the tension in the inner liner can be reduced, but the folding is less satisfactory initially since the fold indication becomes less distinct, see FIG. 12. This is due to the fact that the structure or composition of the corrugated board with intact flute tubes has been destroyed, which means that the initial folding can, in principle, take place in different positions in the deformed area. The stacking strength of the corrugated board boxes is also negatively affected by the fact that the corrugated board is deformed in the corners of the boxes and cannot contribute any more to the good stacking strength, which is an important and desirable feature. The flute tube structure of the corrugated board is important for the stacking strength. By the undesirable deformation of a region of the box corners, the strength of the flute tubes is reduced around the box corners in a region which is very important for the stacking strength. Different board grades also require different designs of both the creasing and the pre-creasing profiles. The great variation of the grades of corrugated board, not to mention the increasing amounts of corrugated board liner (paper) based on recycled fibres, reduces the possibilities of achieving satisfactory folding. Changing the creasing and pre-creasing profiles is time-consuming and complicated. In practice, this is not possible when manufacturing different corrugated board sheets in the in-line machine.

In recent years, some in-line machines have been equipped with systems for automatic change of creasing profiles. However, the fundamental problems of how to deal with tensions occurring in the inner liner of the box and the bead formation around the folding line in the final folding are still not solved or fully addressed.

By actively guiding the folding belt 7, 8 (see FIG. 13) in the folding section of the machine where the critical final folding takes place, it is possible to affect the folding precision to some extent. In some cases, in-line machines are equipped with creasers at the inlet of the folding section. Also this type of device has been found to have a limited effect.

Another technique of affecting the variations in folding due to different grades of the corrugated board is to act on the folded corrugated board sheet at a later stage, after folding, by means of horizontally oriented guide rollers 77, 78, as shown in FIG. 14. However, this technique has been found to have a limited effect on the folding precision, as the guide rollers tend to upset the corrugated board instead of correcting and reducing the variations in folding, see FIG. 15. As a rule, the folding takes place along the flute tubes, where the corrugated board is relatively ductile and less resistant than transversely to the flute tubes.

The reason for the limited effects of prior-art technique is that it has not been possible to affect at the right moment the tension occurring in the contact between the panels 55-58 of the box blanks 18 around the folding line 74 (53). Nor has it been possible to affect in a satisfactory manner the undesired bead formation 75, 76 at the inside (72) of the panels around the folding line 74.

Therefore one object of the present invention is to produce a folding unit for corrugated board sheets in in-line manufacturing of corrugated board boxes, providing high folding precision of the corrugated board sheets.

Another object of the invention is to provide a folding unit for corrugated board sheets which are to be used as corrugated board boxes, allowing a reinforcement of a fold indication which is too unpronounced, in a station of the folding unit arranged after the creasing station, as seen in the transport direction of the corrugated board sheets, to achieve better folding precision.

Yet another object of the invention is to provide a folding unit for folding together (corrugated) board sheets in an in-line machine, in which the setting of the different components of the folding unit is performed from an operating and setting console which also controls other units in the in-line machine, based on input data concerning the dimensions and properties of the corrugated board sheet.

These objects have been achieved according to the invention by a folding unit according to that stated by way of introduction, which is characterised in that a post-creaser is adjustably positioned under the respective folding beams, between the rear end of each folding rule, as seen in the transport direction, and said front deflecting roller, and that each post-creaser comprises a creasing wheel, which is formed as a pair of frustoconical elements, whose bases are directed towards, or integrated with, each other, and a vertically adjustable bracket, which is displaceably arranged transversely to said transport direction and at the upper end of which the creasing wheel is rotatably mounted at an angle to the respective folding beams.

A method for using the creasing unit according to the invention is characterised by the step of deforming, during the folding process, the beads forming at the folding line in the corrugated board sheet during folding by pressing the beads into the corrugated board sheet towards the opposite side of the corrugated board sheet.

Further developments of the invention will become apparent from the features stated in the dependent claims.

A preferred embodiment of the invention will now be illustrated for the purpose of exemplification and with reference to the accompanying drawings, in which:

FIG. 1 is a schematic side view showing the structures of various corrugated board sheets;

FIG. 2 is a top plan view of a sheet of board or corrugated board that is to be folded into a double-folded container or box blank for subsequent erection;

FIG. 3 shows an example of so-called fishtailing which arises from defective folding;

FIG. 4 shows an example of correct folding;

FIG. 5 illustrates a fold indication which can determine exactly where the folding is to take place and a completed folding of a (corrugated) board sheet;

FIG. 6 illustrates crack formation in a fold indication of a (corrugated) board sheet which is manufactured with an increased amount of recycled fibres;

FIG. 7 illustrates an unpronounced fold indication to avoid crack formation in a (corrugated) board sheet which is manufactured with an increased amount of recycled fibres;

FIG. 8 shows the formation of beads at the final stage of the folding of the (corrugated) board sheet;

FIGS. 9a-9c show various final results of the folding of (corrugated) board sheets according to prior-art technique;

FIG. 10 illustrates the deviation in precision in (corrugated) board sheets of different thicknesses;

FIGS. 11a and 11b are cross-sectional views of a prior-art creaser and pre-creaser, respectively;

FIG. 13 shows the folding of a (corrugated) board sheet by active guiding of a folding belt according to prior-art technique;

FIG. 14 shows a prior-art device for correcting the folding of (corrugated) board sheets;

FIG. 15 illustrates the result often obtained when using the device according to FIG. 14;

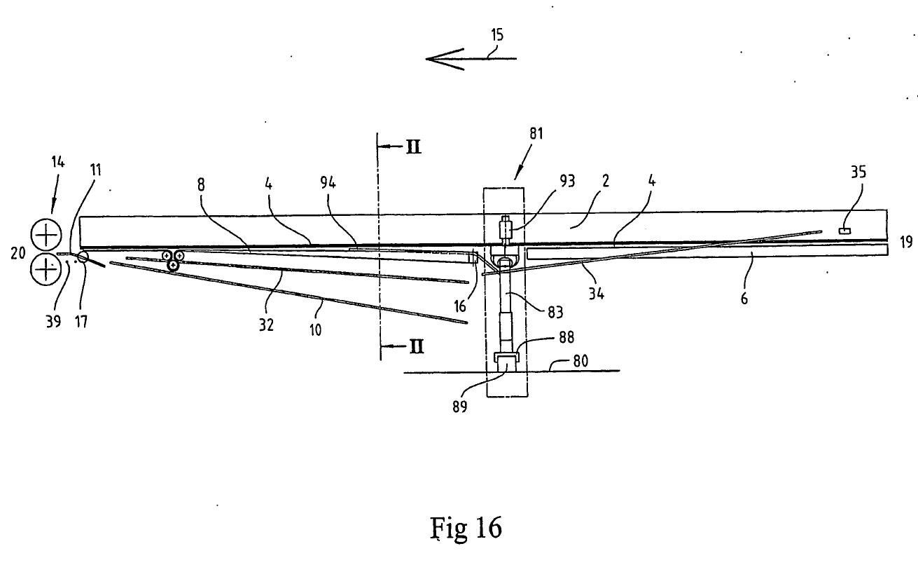

FIG. 16 is a side view which schematically illustrates the structure of the folding unit;

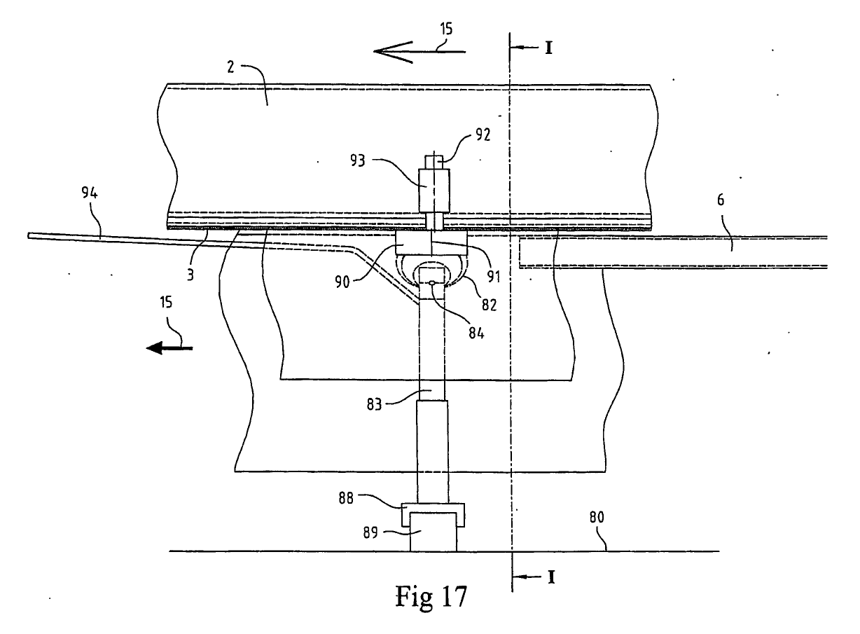

FIG. 17 shows on a larger scale the framed side view in FIG. 16 of the post-creaser according to the invention;

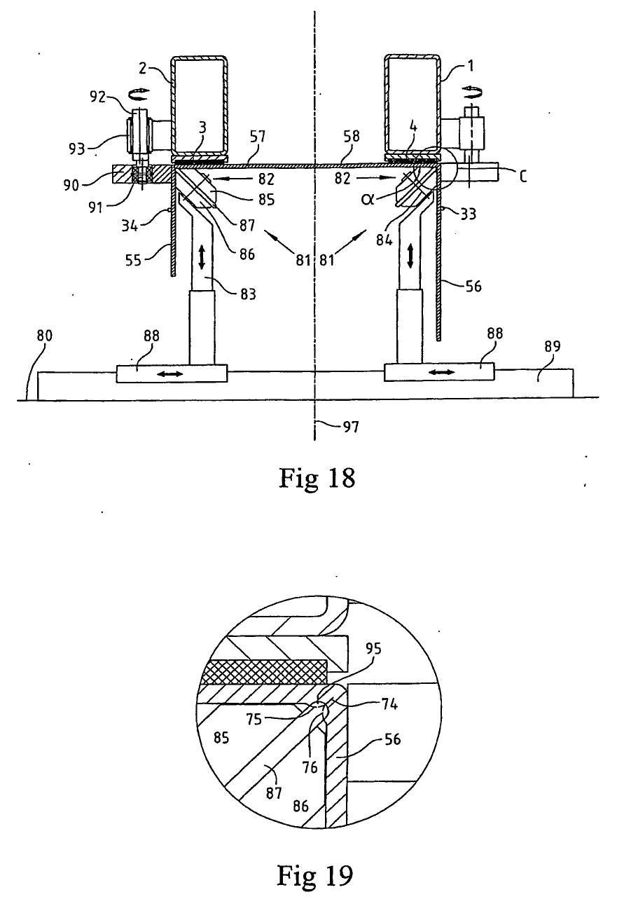

FIG. 18 is a cross-section along the line I-I in FIG. 17 showing the structure of the post-creaser, seen in the transport direction of the (corrugated) board sheets;

FIG. 19 shows the encircled area C in FIG. 18 on a larger scale;

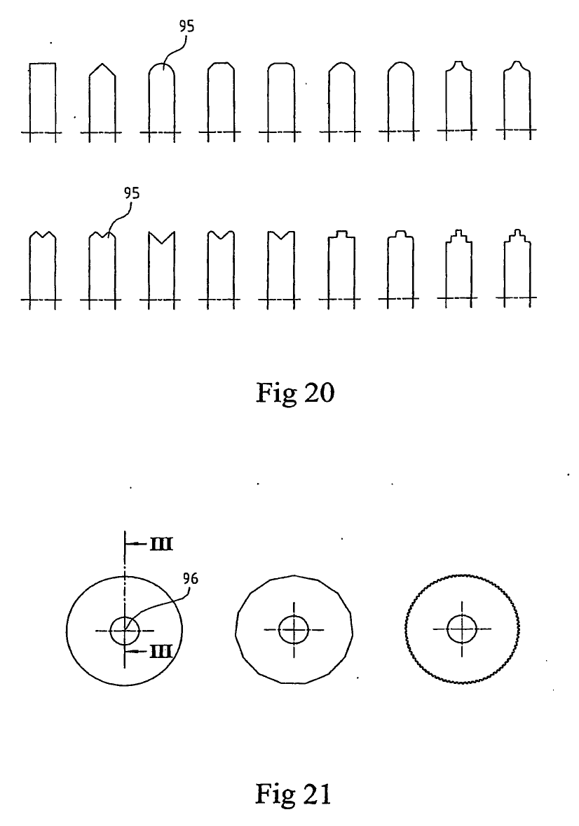

FIG. 20 shows in cross-section a number of embodiments of the circumferential edge of the creasing plate;

FIG. 21 shows in plan view some embodiments of the creasing plate;

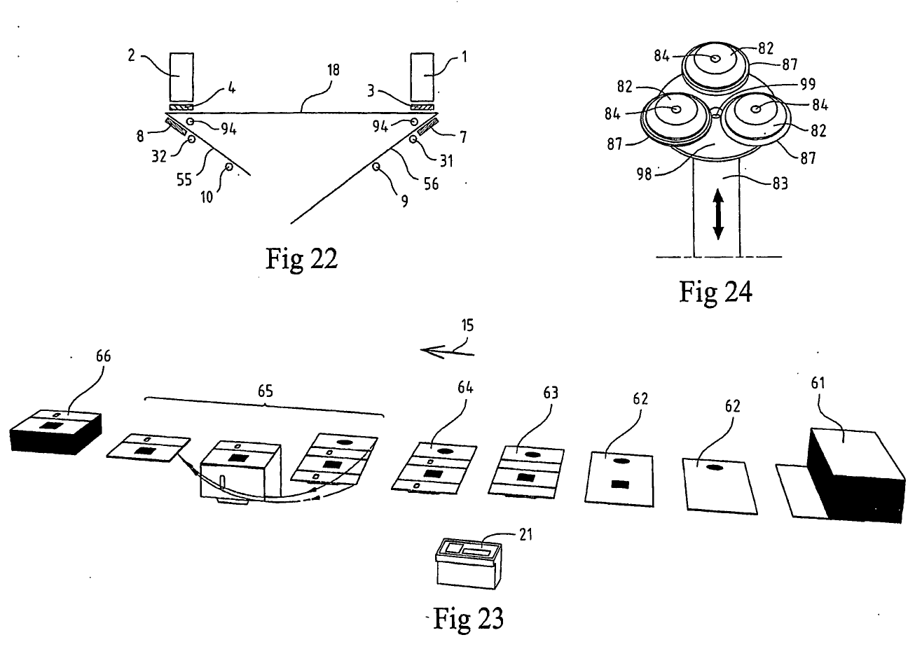

FIG. 22 is a cross-section along the line II-II in FIG. 16 showing the structure of the folding unit after the post-creaser, seen in the transport direction of the (corrugated) board sheets;

FIG. 23 is a diagram of an in-line machine for manufacturing corrugated board boxes and the units included in the same as well as their automation according to the invention; and

FIG. 24 illustrates an alternative embodiment of the post-creaser.

With reference first to FIG. 16, which schematically illustrates the structure of the folding unit, the folding unit comprises a pair of parallel, right and left folding beams 1, 2 (see also FIG. 18), which extend continuously from the inlet 19 of the folding unit, i.e. where the corrugated board sheets 18 are fed into the folding unit, to the outlet 20 of the folding unit, where the corrugated board sheets 18 are fed into a pair of rolls 14 or some other device interconnecting the outer panels 55, 56 of the corrugated board sheet or the box blank. The folding beams 1, 2 are displaceably carried by supports (not shown) of a machine base arranged on a floor 80 and can be moved laterally, i.e. transversely to the transport direction 15 of the corrugated board sheets 18, by means of associated operating means (not shown). The operating means are, for instance, a pair of actuators attached to the associated support and folding beam, as can be easily understood by a person skilled in the art.

The folding beams 1, 2 are preferably box-shaped and each connected to a suction device, such as a fan (not shown) to create a negative pressure in the folding beams. At the underside of the folding beams, there are through grooves or slots and adjacent the underside of the folding beams 1, 2 a right and a left conveyor belt 3, 4 extend along the underside of the folding beams from the inlet 19 of the folding unit to its outlet 20. The conveyor belts 3, 4 are endless and run between a driven and an idle deflecting roller, as known by a person skilled in the art. The conveyor belts 3, 4 are provided with a plurality of through holes, the corrugated board sheets 18 being sucked onto the conveyor belts by the negative pressure in the folding beams 1, 2 and safely transported through the folding unit in the transport direction 15.

Under each folding beam 1, 2, a right and a left folding rule 6, respectively, are arranged, which extend along the respective folding beams and under the conveyor belts 3, 4 from the inlet 19 of the folding unit and towards, but not all the way to, the outlet 20 of the folding unit, as will be explained in more detail below. The folding rules 6 are laterally movable together with the associated folding beam 1, 2. The smallest possible box format, i.e. the smallest possible width of the corrugated board sheet 18, and in particular the panels 57 and 58, depends directly on the width of the folding beams 1, 2 and on how closely they can be moved transversely to the transport direction 15.

In the front portion or half of the folding unit, as seen in the transport direction, a right and a left folding bar 33, 34 are fixedly arranged outside, and in cooperation with, the respective folding rules 6. The folding bars 33, 34 extend from a point over and at the outside of the respective folding rules 6 to a point 5 substantially in the same vertical plane as and vertically under the associated folding rule 6.

At the inlet 19 of the folding unit, outside and above one of the folding rules and, as seen in the transport direction 15, in front of its associated folding bar, a glue nozzle with control means 35 is positioned, whose position is adjusted to the position of the glue flap 59 of the corrugated board sheet 18 which is being fed.

Corrugated board sheets 18 are fed one by one and at a regular rate at the inlet of the folding unit, gripped by the pair of conveyor belts 3, 4 and transported along the folding rules 6. In this connection, glue is first applied from the glue nozzle 35 to the glue flap 59 of the corrugated board sheet, after which the outer panels 55, 56 of the corrugated board sheet 18 are caught by the folding bars 33, 34, which in cooperation with the respective folding rules 6 successively fold down the outer panels, along their creasing lines 53, from 180° (flat corrugated board sheet) to 45°-150°, preferably 60°-120° and more preferably 80°-100°.

After the above-mentioned end point or extremity of the folding bars 33, 34, as seen in the transport direction 15, and at a distance from the same, a right and a left endless folding belt 7, 8 are arranged under a respective folding beam 1, 2 to cooperate therewith. Each folding belt 7, 8 extends from an associated deflecting roller 16 with a substantially vertical axis at said end point of the respective folding bars 33, 34 to an associated deflecting roller 17 with a horizontal axis substantially adjacent the pair of rolls 14, see FIG. 16. The folding belts 7, 8 are thus turned from a substantially vertical orientation at the deflecting roller 16 to a horizontal orientation at the deflecting roller 17. The folding belts 7, 8 cooperate with the associated folding beam 1, 2 and successively turn the outer panels 55, 56 of the corrugated board sheet 18 towards its inner panels 57, 58 until the outer panels substantially abut the inner panels, i.e. a turning of the outer panels from 0° at the inlet 19 of the folding unit to about 180° at the horizontal deflecting roller 17.

Preferably, the folding unit also comprises a right and a left support bar 31, 32, which have substantially the same extension in the transport direction 15 as the folding belts 7, 8. These support bars 31, 32 serve to support the outer panels 55, 56 which are folded and assume, due to their flexibility, an angle or vertical position in relation to the inner panels 57, 58 of the corrugated board sheet that is advantageous for the folding of the panels 55, 56 and adapted to the turning angle of the folding belts 7, 8 in the transport direction 15. Advantageously, the folding unit also includes a right and a left bar-shaped panel support 9, 10, preferably double-bent, which have substantially the same extension in the transport direction 15 as the folding belts 7, 8 (and the support bars 9, 10) and which can be pivoted from an inactive position at the bottom of the machine base (not shown) to an active position inwardly of the pair of support bars 31, 32 to support, if needed, the folding of wide. outer panels 55, 56. It has been found that the panel supports 9, 10 have a very favourable effect on the precision when folding large corrugated board sheets 18.

At the end of the support bars 32 and the panel supports 9, 10, and between them, a guide bar 11 is movably arranged on two shafts 39 transversely to the transport direction 15 and just in front of the pair of rolls 14, see FIG. 16. The guide bar 11 is movable parallel with the pair of rolls 14. The guide bar 11 can be laterally moved to a position for optimal guiding of folded corrugated board sheets 18 towards the gap between the pair of rolls 14. The pair of rolls 14 are stationary fastened to the support of the folding unit at its outlet 20 and the roll nip is adjusted depending on the thickness of the sheet and the desired roll pressure.

For a more detailed presentation of a folding unit in which a post-creaser 81 according to the present invention can suitably be used, see Swedish patent application 0501943-5, filed on 2 Sep. 2005 in the name of the same applicant.

With further reference to FIGS. 17 and 18, which are a side view and a view in the transport direction, respectively, the post-creaser 81 according to the invention will now be described more precisely.

The subject matter of the invention is a pair of post-creasers 81 which are arranged in the folding distance of the folding unit or the in-line machine in a position, in which the folding of the outer panels 55, 56 of the (corrugated) board sheet 18 is partly completed, for instance in the centre area of the folding unit, seen in the transport direction 15, as shown in FIG. 16. Each post-creaser 81 is adjustably positioned under, and in cooperation with, the respective folding beams 1, 2. Seen in the transport direction 15, the post-creasers 81 are preferably positioned flush with each other, between the rear ends of the respective folding rules 6 in the transport direction and before the front deflecting rollers 16. Advantageously, the positioning of the post-creasers 81 in the folding unit coincides with a position corresponding to an approximately 90° folding of the outer panels. However, the invention also includes other positions in which sufficiently pronounced and fully adjustable post-creasing can be performed. The post-creasing can thus be carried out when the outer panels have been folded 45°-150°, preferably 60°-1200 and more preferably 80°-100°.

The function of the post-creaser is to provide sufficiently pronounced post-creasing which can be optimally adjusted to the other settings of the folding unit. The object of the post-creasing is to deform the beads 75, 76 (see FIGS. 8 and 19) which form during folding, thereby reducing the above-mentioned variations that occur as a direct effect of the bead formation.

The description hereinafter applies to in-line machines in which printing is performed from the top side and the sheets are folded downwards, as shown in FIG. 23. The invention is however equally applicable to machines in which printing is performed from the underside and the sheets are folded upwards.

Each post-creaser 81 comprises a creasing wheel 82 and an associated bracket 83 at the upper end of which the creasing wheel 82 is rotatably mounted on a shaft 84 which forms an angle a of less than 90° with the underside of the folding beam 1, 2, the conveyor belts 3, 4 and the inner panel 57 of the corrugated board sheet 18. The creasing wheel 82 is formed as a pair of frustoconical elements 85, 86 with a cone angle 2a, whose bases are directed towards each other and whose top surfaces are thus facing away from each other, cf. FIG. 18. The elements 85, 86 are preferably formed as identical, separate elements, but they can also be formed in one piece if the integral bases of the elements are formed as a projecting creasing plate, as will be described below.

The outer element 85 is oriented so that its frustoconical circumferential surface can be brought into abutment against the inner panel 57, 58 and press the same against the respective conveyor belts 3, 4 which, in their turn, are supported by the associated folding beam 1, 2. The inner element 86 then abuts against the outer panel 55, 56 of the corrugated board sheet 18 and presses the same against an abutment, for instance a wheel, as shown in FIG. 18 and as will be discussed more fully below. The cone angle 2a of the elements is selected such that the post-creasing will be performed when the outer panel 55 has been folded, from the plane of the inner panel 57, at an optional angle in the range of 45°-150°, preferably in the range of 60°-120° and more preferably in the range of 80°-100°, as already discussed above. In FIG. 18, the post-creasing is performed at an angle of 90° between said panels. By adding a post-creasing step when the outer panels of the sheet are partly folded, a fold indication that is too unpronounced can be increased and better folding precision obtained. That is due to the fact that the tension in the inner liner changes during folding, which allows additional creasing by the post-creaser.

With reference to FIGS. 18-20, the creasing wheel 82 comprises said frustoconical elements 85, 86 and a creasing plate 87 which is replaceably arranged between the elements and whose circumferential edge projects from the bases of the elements 85, 86. The elements 85, 86 and the creasing plate 87 are rotatably mounted by ball bearings on said shaft 84 for free rotation about the same due to the motion of the conveyor belts 3, 4. As an alternative, the creasing wheel 82 can, of course, be motor-driven and controlled by an operating and setting console which will be presented below. It is this creasing plate that performs the actual post-creasing. As the corrugated board sheets pass between the creasing wheel B2 and an abutment, the inner liner 72 of the corrugated board sheets is affected in the area of the folding line 74. The tension built up in the inner liner of the corrugated board sheets when folding the outer panel of the boxes by the contact pressure in the area of the folding line between the folded panels will be counteracted and reduced by the back pressure applied by the creasing plate 87 at the same time as the beads 75, 76 around the folding lines are deformed, see FIG. 19. By reducing the tension in the inner liner and by deforming the bead formation, it is possible to control the folding and to limit the reduced folding precision due to the properties of different corrugated board grades. It is not until the tension has built up in the inner liner, due to folding, that the post-creasing has the intended effect. Therefore post-creasing should be performed when this state has been reached. At the same time, the folding must not have proceeded so far that the tension in the inner liner affects or takes over and controls the folding. The critical range is between 10° to about 160° folding, cf. the above-discussed ranges.

The design of the profile of the creasing plate 87 in the post-creaser can vary depending on the grade of the corrugated board. Therefore the invention comprises a great number of different creasing profiles that can become of use. Fundamental shapes that can be used for the creasing profiles of the invention are shown in FIG. 20. Each fundamental shape can include a great number of variations as to widths, angles, etc. Thus, in FIG. 20, the upper row and the lower row to the right illustrate a number of variants of the circumferential edge 95 of a creasing plate in a cross-section III-III through its axis of rotation 96 (cf. FIG. 21), which all have in common that the circumferential edge 95 is substantially convex. On the other hand, the lower row to the left illustrates some variants in which the circumferential edge 95 is substantially concave. Furthermore, the circumference of the creasing plate 87 is shown as circular but, if needed, it can also be polygonal or toothed, as shown in FIG. 21.

A device allowing automatic change between different creasing profile widths and/or different creasing profiles is shown in FIG. 24. This alternative embodiment of the post-creaser 81 is shown in a view in the transport direction 15, i.e. in a partial view from the line 97 in FIG. 18. This device is designed as a turret head, for instance in the form of a turret plate 98, which is rotatably adjustable about a shaft 99 and which rotatably supports two or more small creasing wheels 82. The shaft 99 is fastened to the upper end of the bracket 83, in a manner corresponding to that of the shaft 84 in FIG. 18. Each creasing wheel 82 is rotatably fastened with its associated shaft 84 to the turret plate 98. In the embodiment shown in FIG. 24, the turret plate 98 is stepwise adjustable to three positions, so that one of the creasing wheels 82 will always be active and deform the formed beads 75, 76. The creasing wheels 82 have creasing plates 87 with differently formed profiles. In this embodiment, the creasing wheel and the selected profile can easily be brought into an active position instead of the operator having to dismount a currently used creasing wheel and mount a new one, as in the embodiment according to FIG. 18.

With reference again to FIG. 18, each creasing wheel 82 is, as already stated, rotatably mounted at the upper end of an associated bracket 83. As the bracket is expansible in the vertical direction, preferably by being telescopic, the position of the creasing wheel can be vertically adjusted by an operating means (not shown), such as a hydraulic cylinder, which is attached to the telescopic portions of the bracket 83 and which is connected to the above-mentioned operating and setting console. At the lower end of each bracket 83, a mounting carriage 88 is fastened, said two mounting carriages running on a guide and support rail 89 which is fixedly fastened to the floor 80 at right angles to the transport direction 15 of the corrugated board sheets 18, cf. FIG. 16. The lateral position of the creasing wheels 82 is thus adjusted by the mounting carriages 88 being moved on the guide and support rail 89 by operating means (not shown), such as hydraulic cylinders, which are connected to the above-mentioned operating and setting console.

As stated above, in the post-creasing operation, the outer element 85 of the creasing wheel 82 presses the inner panel 57, 58 of the corrugated board sheet 18 against the supported conveyor belt 3, 4, the inner element 86 then pressing the outer panel 55, 56 of the board sheet against an abutment, while the creasing plate 87 simultaneously performs said post-creasing. As a suitable abutment for the inner element 86, a free-running or driven abutment wheel 90 is rotatably arranged on a shaft 91. In the case of a cylindrical abutment wheel, the shaft 91 is oriented parallel with the frustoconical envelope surface of the inner element 86 at its contact with the outer panel 55, 56, in the vertical direction in the embodiment shown in FIG. 18. It goes without saying that conical abutment wheels are also feasible, and in that case the shaft 91 has, of course, some other orientation. The circumferential surface of the abutment wheel is arranged opposite the circumferential surface of the inner element. As a result, the outer panel is clamped and fixed between the abutment wheel 90 and the inner element 86, whereas the inner panel 57 is clamped and fixed between the conveyor belt 3, 4 and the outer element 85. The design of the creasing head thus contributes to the stabilisation and the guiding of the creasing plate into the right position by its exterior surfaces being parallel with, on the one hand, the abutment wheel and, on the other hand, the conveyor belt 3, 4.

The shaft 91 of the abutment wheel is in its turn attached to or integrated with an eccentric shaft 92, which is adjustably suspended in a housing 93 that is preferably provided with an operating device (not shown) for turning the eccentric shaft 92 and thereby moving the abutment wheel 90 towards or away from the creasing wheel 82. Each housing 92 is fixedly attached to the outside of the respective folding beams 1, 2, substantially straight above the guide and support rail 89.

To each post-creaser 81, a guiding rod 94 is preferably attached which extends towards, but not all the way to, the pair of rolls 14 and is positioned in the folding area of the board sheet, i.e. between the folding belt 7, 8 and the conveyor belt 3, 4, as most clearly seen in FIG. 22. The guiding rod 94 assists the guiding of the outer panel 55 in the folding process.

The function of the guiding rod 94 is to guide the box flaps so as to prevent them from being pressed inwardly and getting blocked. The guiding rod thus replaces the portions of the folding rules 5, 6 which, in the folding unit according to the above-mentioned Swedish patent application 0501943-5, are arranged after the deflecting rollers 16, seen in the transport direction 15.

After having described the structure of the folding unit, its function will now-be described.

After the above-described folding of the outer panels 55, 56 from 0° to 90° according to the shown embodiment in the front portion or half of the folding unit, seen in the transport direction 15, the outer panels 55, 56 are brought into engagement with the respective folding belts 7, 8 for continued successive folding inwards towards the inner panels 57, 58. Subsequently, as the corrugated board sheets 18 approach the rear deflecting rollers 17, the outer panels 55, 56 are folded almost 180° towards the inner panels 57, 58. The bent guide bar 11 then catches the folded panels 55, 56 and guides them together with the panels 57, 58 into the nip of the pair of rolls 14, where a glue flap 59 of the outer panel 55 is pressed against and adhered to the other outer panel 54. The adjustment of the guide bar, which is performed laterally based on the relationship between the narrow and the wide outer panels of the box, is motor-driven and automatically adjusted by the console 21 to the right position.

The folding belts 7, 8, which guide the folding of the outer panels 55, 56 from 90° to 180° in the shown embodiment, are driven at a 2% to 3% higher speed than the rest of the machine by means of the horizontal deflecting rollers 17.

Owing to the effect on the panels caused by the pivoting during folding, the chances of achieving optimal folding increase the longer the folding distance of the machine. For economical reasons and for considerations of space, it is however necessary to limit the length of the folding distance. To obtain optimal folding over the limited length of the folding distance, the folding motion should be as gentle as possible and the folding distance optimally used. In machines with manual adjustment, the machine operator is assigned the task of adjusting the folding motion. This work is both time-consuming and knowledge-demanding and results in more or less optimal settings with varying quality of the folding of the boxes as a direct consequence thereof.

FIG. 23 schematically illustrates the structure of an in-line machine for manufacturing corrugated board boxes and the units included in the same as well as their automation according to the invention. The setting of the various machine units, i.e. the inlet 61, the printing unit 62, the slotting unit 63, the punching unit 64, the folding unit 65 and the counting and bundling unit 66 are fully motorised and adapted to be pre-programmed, on the one hand, to reduce the changeover time of the machine and, on the other, to ensure as exact and precise settings as possible. These settings are carried out centrally from the operating and setting console 21 and via a connection line to each unit and are readable on a computer screen. The setting of the post-creaser, i.e. the operating means of the brackets 83 and the mounting carriages 88, the operating device of the abutment wheel 90 and the rotary engines of the creasing wheel 82 and/or the abutment wheel 90, is advantageously also carried out from the operating and setting console 21.

By the motorization of the settings of the folding motion, an important, demanding and difficult machine setting process is automated. Previously, to perform the manual setting, it was necessary for the operator to enter the area of the folding unit that is closed for safety reasons when the machine is run. This meant that the machine had to be stopped which resulted in important loss of time and that the setting of the machine depended on the operator's ability and knowledge. With the system according to the invention, the setting of the folding motion for each box blank that is to be run through the machine is accommodated to a calculated, optimal setting value. On the basis of this setting, the operator can, if needed, make fine adjustments depending on the operating conditions, such as the machine speed and the corrugated board grade. Owing to the motorization of the settings, they can be performed during operation in a safe manner for the machine operator. The optimal setting can then be stored in a database, together with all other settings of the machine, so that the machine can be automatically set up to previous optimal settings in the case of recurrent orders.

In the folding unit described above, the outer panels of the sheets are folded downwards. As will be easily understood by a person skilled in the art, it is also possible, and in some cases desirable, to fold the outer panels upwards instead, which is achieved by the various elements of the folding unit that have been shown as positioned above the transport plane of the sheets being mirror-invertedly positioned under, and in relation to, the transport plane and vice versa.

Furthermore, the sheet has continuously been referred to in this text as “corrugated board sheet”. It goes without saying that the invention is also applicable to other types of board than corrugated board.

The invention is not limited to that described above and shown in the drawings and can be modified within the scope of the appended claims.

1. A folding unit for corrugated board sheets in in-line manufacturing of corrugated board boxes, comprising a pair of parallel and laterally displaceable folding beams with a respective endless conveyor belt, which extend from the inlet of the folding unit to the outlet of the folding unit, a pair of folding rules, which are arranged under the respective folding beams and which extend from the inlet of the folding unit and towards, but not all the way to, the outlet of the folding unit, a pair of folding bars, which are fixedly positioned outside the respective folding rules and at an angle to the respective folding rules and which are arranged in the front portion of the folding unit, as seen in the transport direction of the corrugated board sheets, a pair of folding belts, which are arranged under a respective folding beam to cooperate therewith and which extend from an associated front deflecting roller after the terminal end of the folding bars, as seen in the transport direction to an associated deflecting roller with a horizontal axis substantially adjacent the outlet, a corrugated board sheet supplied to the inlet of the folding unit being gripped by said pair of conveyor belts, being transported along the folding rules, and the two outer panels of the corrugated board sheet being folded successively from 0° by the respective folding bars in cooperation with the associated folding rule, after which each folded panel is brought into engagement with the respective folding belts and the folding beam cooperating therewith for continued folding and subsequently leaves the respective folding beams to be finally delivered at the outlet by the pair of deflecting rollers with a horizontal axis, with the panels folded 180°, wherein a post-creaser is adjustably positioned under the respective folding beams, between the rear end of each folding rule, as seen in the transport direction, and said front deflecting roller, and that each post-creaser comprises a creasing wheel, which is formed as a pair of frustoconical elements, whose bases are directed towards, or integrated with, each other, and a vertically adjustable bracket, which is displaceably arranged transversely to said transport direction, and at the upper end of which the creasing wheel is rotatably mounted at an angle to the respective folding beams.

2. A folding unit as claimed in claim 1, wherein the cone angle of the pair of elements is in the range of 80°-100°.

3. A folding unit as claimed in claim 1 wherein the frustoconical elements of each creasing wheel are each formed as a separate unit and that a substantially circular creasing plate is arranged to project between the elements, the elements and the creasing plate being arranged on a common shaft.

4. A folding unit as claimed in claim 3, wherein the circumferential edge of the creasing plate in a cross-section through its axis of rotation is substantially convex.

5. A folding unit as claimed in claim 3, wherein the circumferential edge of the creasing plate in a cross-section through its axis of rotation is substantially concave.

6. A folding unit as claimed in claim 3, wherein the circumference of the creasing plate is polygonal or toothed.

7. A folding unit as claimed in claim 1, wherein an abutment wheel is rotatably fastened via a shaft and a housing to each folding beam, and that each abutment wheel is positioned opposite the conical element of the respective creasing wheels closest to the bracket to nip between them the outer panel of the corrugated board sheet.

8. A folding unit as claimed in claim 7, wherein each abutment wheel is arranged to be displaceable towards and away from said conical element.

9. A folding unit as claimed in claim 1 wherein the setting of the brackets in the vertical direction and transversely to the transport direction, the setting of the abutment wheels transversely to the transport direction, the rotation of the abutment wheels and/or the rotation of the creasing wheels are controlled from an operating and setting console, in which the dimensions and properties of the corrugated board sheets have been input and which allows fine adjustment during operation of the folding unit.

10. A folding unit as claimed in claim 1, wherein the post-creaser comprises at least two creasing wheels, which are rotatably mounted on a turret plate which in its turn is stepwise settably fastened to said bracket.

11. A folding unit as claimed in claim 1, wherein a guiding rod (94) is fixedly fastened with one of its ends to each post-creaser (81), at the same side as its creasing wheel (82) in relation to the outer panel (54, 55) of the corrugated board sheet (18), the other end extending towards, but not all way to, the outlet (20) of the folding unit.

12. A method of folding corrugated board sheets in in-line manufacturing of corrugated board boxes, comprising the steps of feeding at a regular rate corrugated board sheets into a folding unit during sizing, successively folding, in the first portion of the folding unit, as seen in the transport direction of the corrugated board sheet, the two outer panels of the corrugated board sheet from 0° by means of a pair of folding beams and a pair of folding bars cooperating therewith, successively folding, in the second portion of the folding unit, as seen in the transport direction of the corrugated board sheet, the two outer panels of the corrugated board sheet to 180° by means of a pair of folding belts and said pair of folding beams ,and guiding, by means of a guide bar, the folded corrugated board sheet between a pair of rolls for adhering a glue flap of one of the folded panels to the other folded panel, wherein by the step of deforming, during the folding process, the beads forming at the folding line in the corrugated board sheet during folding by pressing the beads into the corrugated board sheet towards the opposite side of the corrugated board sheet.

13. A method as claimed in claim 12, wherein the beads at each folding line are pressed into the corrugated board sheet by means of a creasing wheel which is formed as a truncated double-cone and cooperates with the folding beam acting as abutment and with an abutment wheel rotatably fastened to the folding beam.

14. A method as claimed in claim 13, wherein the step of fine adjusting during operation the position of the creasing wheel in relation to the lower and outer sides of the folding beam by a first operating means for the vertical position of the creasing wheel and a second operating means for the position of the creasing wheel transversely to the transport direction of the corrugated board sheets being remote-controlled from an operating and setting console.
